(19) United States
(12) Patent Application Publication
(10) Pub. No.: US 2014/0219331 A1
(43) Pub. Date: Aug. 7, 2014

(54) APPARATUSES AND METHODS FOR PERFORMING JOINT RATE-DISTORTION OPTIMIZATION OF PREDICTION MODE

(71) Applicant: MAGNUM SEMICONDUCTOR, INC., Milpitas, CA (US)

(72) Inventors: Cheng-Yu Pai, Kitchener (CA); Krzysztof Hebel, Kitchener (CA); Lowerll Winger, Waterloo (CA)

(73) Assignee: Magnum Semiconductor, Inc., Milpitas, CA (US)

(21) Appl. No.: 13/760,871

(22) Filed: Feb. 6, 2013

(51) Int. Cl. H04N 7/26

(52) U.S. Cl. CPC H04N 19/00175
USPC 375/240.02

(57) ABSTRACT

Examples of apparatuses and methods for performing a joint RD optimization operation are described herein. A method may include successively encoding a macroblock using a plurality of coding modes. The method may further include determining a corresponding rate-distortion cost to encode the macroblock based on a corresponding coding mode of the plurality of coding modes. The method may further include determining a corresponding estimated rate-distortion cost to encode one or more macroblocks affected by encoding the macroblock using the corresponding coding mode. The method may further include selecting a coding mode of the plurality of coding modes having a lowest corresponding joint rate-distortion cost. The corresponding total rate-distortion cost comprises the corresponding rate-distortion cost to encode the macroblock and the corresponding estimated rate-distortion cost to encode the one or more of the affected macroblocks.

### TECHNICAL FIELD

Embodiments described relate to video encoding, and in particular to performing a joint RD optimization operation.

### BACKGROUND

Typically, signals, such as audio or video signals, may be digitally encoded for transmission to a receiving device. Video signals may contain data that is broken up in frames over time. Due to high bandwidth requirement, baseband video signals are typically compressed by using video encoders prior to transmission/storage. Video encoders may employ a coding methodology to encode macroblocks within a frame using one or more coding modes. In many video encoding standards, such as MPEG-1, MPEG-2, MPEG-4, H.261, H.262, H.263, H.264, etc., a macroblock denotes a square region of pixels, which is 16×16 in size. Most of the coding processes (e.g. motion compensation, mode decision, quantization decision, etc.) occur at this level. Note that in HEVC, the concept of macroblock is extended to larger block size referred as coding unit. Without loss of generality, this invention uses the term macroblock to represent a basic coding unit. The coding methodology may select a coding mode from one or more coding modes based on a balance of a desired quality of the encoded macroblock versus a bandwidth cost to transmit the encoded macroblock, commonly referred to as rate-distortion (RD) optimization. In order to increase efficiency, some encoding standards provide mechanisms to utilize some of the information from previously encoded macroblocks to form prediction that may be used during encoding of a current macroblock. Typically, selection of a coding mode for a macroblock does not account for an effect the selected coding mode may have on encoding of subsequent macroblocks. Thus, selection of an optimum coding mode for a previous macroblock may increase rate-distortion cost to encode subsequent macroblock(s) within the frame versus selection of an alternative coding mode. Failing to account for the future effect of current macroblock mode decision may result in an overall higher rate-distortion cost to encode and transmit the frame when considered over multiple macroblocks.

### BRIEF DESCRIPTION OF THE DRAWINGS

FIG. 1 is a block diagram of an encoding system with joint RD-optimized mode decision;

FIG. 2 is a schematic block diagram of a an encoding system including a mode decision block with a joint RD cost analyzer and affected/current macroblock RD cost analyzers according to an embodiment of the disclosure;

FIGS. 3a and 3b are schematic block diagrams of examples of macroblocks affected by encoding of a current macroblock according to an embodiment of the disclosure;

FIG. 4 is a flow diagram of a particular illustrative embodiment of a method of performing a joint RD optimization operation;

FIG. 5 is a schematic illustration of a media delivery system according to an embodiment of the invention; and

FIG. 6 is a schematic illustration of a video distribution system that may make use of encoders described herein.

### DETAILED DESCRIPTION

Examples of methods and apparatuses for accounting for estimated cost to subsequent macroblocks in selection of a prediction mode for a current macroblock are described herein. Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

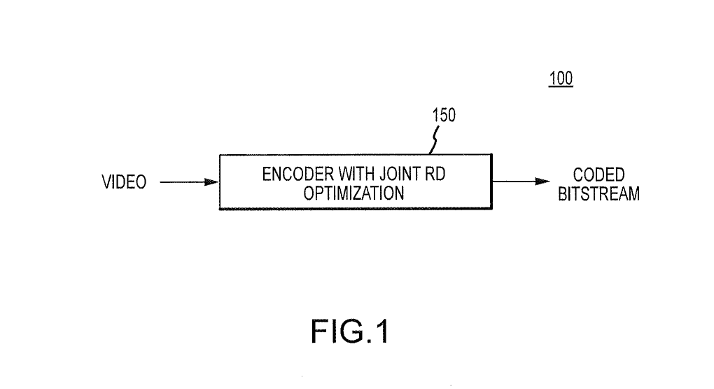

FIG. 1 is a block diagram of an encoding system 100 according to an embodiment of the disclosure. The encoding system 100, which may be implemented in hardware, software, firmware, or combinations thereof, may include an encoder with joint rate-distortion optimization (encoder) 150 that may include control logic, logic gates, processors, memory, and/or any combination or sub-combination of the same, and may be configured to encode and/or compress a video signal to produce a coded bit-stream signal using one or more encoding techniques, examples of which will be described further below. The encoder 150 may be configured to select a coding mode for the current macroblock corresponding to a respective portion of the video signal by performing a joint rate-distortion (RD) optimization operation to optimize a cost of encoding a current macroblock using one of a plurality of available coding modes. The joint RD optimization operation may account for a cost to encode the current macroblock and an estimated cost of encoding one or more macroblocks affected by encoding the current macroblock using one of the plurality of available coding modes.

The encoder 150 may be implemented in any of a variety of devices employing video encoding, including, but not limited to, televisions, broadcast systems, mobile devices, and both laptop and desktop computers. In at least one embodiment, the encoder 150 may include an entropy encoder, such as a variable-length coding encoder (e.g., Huffman encoder, context-adaptive variable length coding (CAVLC) encoder, or context-adaptive binary arithmetic coding (CABAC) encoder), and/or may be configured to encode data, for instance, at a macroblock level. Each macroblock may be encoded in intra-coded mode, inter-coded mode, bidirectionally, or in any combination or subcombination of the same.

As an example, the encoder 150 may receive and encode a video signal that, in one embodiment, may include video data (e.g., frames). The video signal may be encoded in accordance with one or more encoding standards, such as MPEG-2, MPEG-4, H.263, H.264, and/or HEVC, to provide the encoded bitstream. The encoded bitstream may be provided to a data bus and/or to a device, such as a decoder or transcoder (not shown). As will be explained in more detail below, a video signal may be encoded by the encoder 150 using one of a plurality of available coding modes. Selection of the one of a plurality of available coding modes may be based on optimizing a total cost of encoding a current macroblock using a particular prediction mode plus an estimated cost to encode one or more of the affected macroblocks based on encoding of the current macroblock using one of a plurality of available coding modes.

To reduce macroblock header costs for a given coding mode, a prediction based on the mode decisions of previously encoded macroblocks within the same frame may be used to select a coding mode. Thus, the mode decision made to encode one macroblock may affect encoding of subsequent macroblocks that have yet to be encoded.

Encoding of macroblocks within a frame may be based on the joint RD optimization process designed to select a particular rate-distortion trade-off where a sufficient rate is maintained with an allowable amount of distortion. The joint rate-distortion optimization process, which may be performed by the encoder 150, may involve successively encoding a current macroblock using a plurality of coding modes, and for each coding mode, determining a rate-distortion cost using a joint rate-distortion cost function. The joint rate-distortion cost function may include two parts: 1) a cost to encode the current macroblock using the selected coding mode, and 2) an estimated cost to encode subsequent macroblocks affected by encoding the current macroblock using the selected coding mode. The rate-distortion cost to encode the current macroblock may be represented by a weighting factor λ, or lambda, multiplied by the rate and the product added to the distortion.

Cost=λR+D

where R represents the rate (number of bits to encode the macroblock) and D the distortion. The distortion may be calculated using any of a variety of known distortion calculation techniques. The cost for encoding the current macroblock may be combined with the estimated costs for encoding subsequent, macroblocks to generate a joint cost in any of a variety of ways. For example, the estimated costs of encoding subsequent macroblocks may be summed and the sum, or a weighted or scaled version of the sum, may be added to the cost to encode the current macroblock using a selected coding mode. Other methods of computing the joint cost may also be used. In some embodiments, the cost function may use a lambda inverse, e.g., Costₐₗₜ=λ⁻¹*D+R

Denote N to be total number of macroblocks with in a picture, M to be the number of possible modes can be selected per macroblock, and A be the number macroblocks that are considered to be affected by the mode decision of current macroblock n, where n=0 . . . N−1. Then, the joint rate-distortion (RD) cost for current macroblock n in this example may be defined as:

J(n,m₁)=D(n,m₁)+λ*R(n,m₁)+Σ[αₐ*J*(a|m₁)]

where

m₁ (0 . . . M−1) denotes a mode decision for macroblock n,

D(n,m₁) represents distortion of the current macroblock n for coding mode m₁,

R(n,m₁) represents normative rate (and may include header bits, motion vectors, and/or quantized coefficients) of the current macroblock n for coding mode m₁,

αₐ represents a normalization factor to bring the estimated cost into the true rate-distortion cost domain, and

J*(a|m₁) is the estimated RD cost of affected macroblock (a=0 . . . A−1) coded assuming the current macroblock is coded with mode decision m₁. J*(a|m₁) may be defined as:

J*(a|m₁)=minₘ₂{D*(a,m₂)+λₐ*R*(a,m₂)}

where D* and R* denote estimated distortion and bit cost, respectively, of macroblock a coded with mode decision m₂ (0 . . . M−1) which may be different from m₁. λₐ denotes weighting parameter to produce estimated RD cost of macroblock a. λₐ may be provided by user or adaptively computed. J*(a|m1) is the minimum estimated cost of evaluated modes m₂.

Note, in the above equations, the D+λR terms may represent a traditional calculation of the rate-distortion cost associated with encoding the macroblock n using the selected mode, however, the joint cost J also includes a sum of costs associated with encoding other macroblocks once macroblock n had been encoded using the selected coding mode. The normalization factor α may be a constant in some examples, and in other examples may be adaptively determined. The normalization factor α may be provided by a user, or by another component of the encoding system, or may be pre-programmed into the encoding system of FIG. 1. The normalization factor α may generally be selected to balance the effect of the costs of other affected macroblocks vs. the cost of encoding the current macroblock on the total joint cost. A larger α, for example, may reflect a greater importance being placed on the costs for encoding other affected macroblocks. Multiple joint costs J may be calculated for a given macroblock—generally one per coding mode being evaluated—and an encoder may select a coding mode based on the joint cost associated with that mode.

Generally, encoding methods may aim to minimize the joint cost for example, for a given bit rate. Lambda may be determined by the encoder 150 of FIG. 1, may be provided by a device, such as a decoder, transcoder, or logic circuit (not shown), or may be specified by a user.

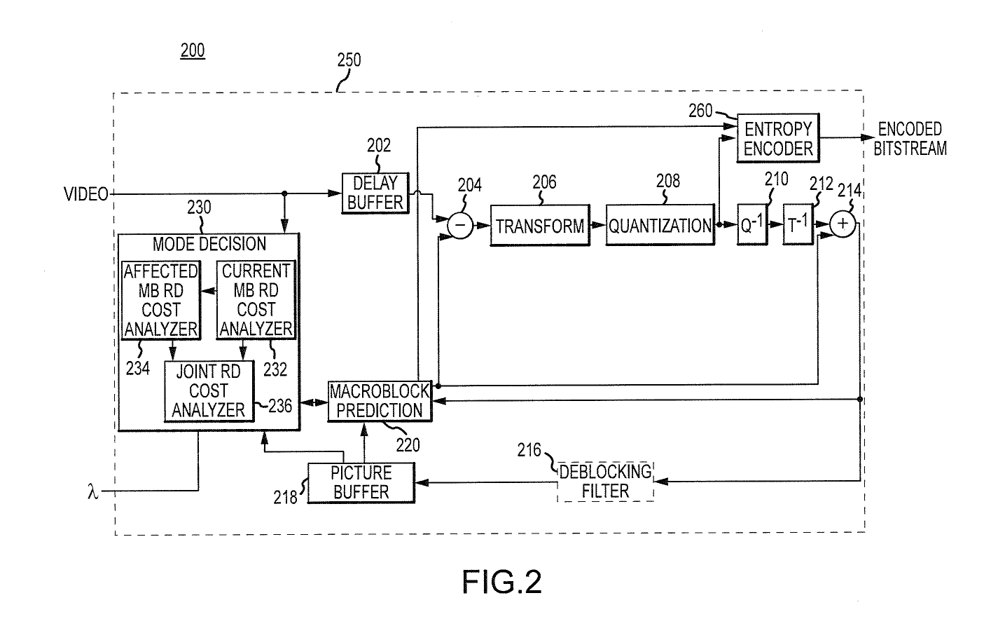

As will be explained in further detail with reference to FIG. 2, the encoder 150 may be configured to successively determine a joint RD cost for a plurality of available coding modes using the joint RD cost function, and select a coding mode of the plurality of available coding modes based on the corresponding joint RD cost.

FIG. 2 is a schematic block diagram of an encoding system 200 according to an embodiment of the disclosure. The encoding system 200 may include an encoder 250 used to implement the encoder 150 of FIG. 1, and may operate in accordance with one or more encoding standards in the art, known now or in the future. The encoder 250 may be implemented in semiconductor technology, and may be implemented in hardware, software, or combinations thereof.

The encoder 250 may include an encoding path having a mode decision module 230, a delay buffer 202, a transform 206, a quantizer 208, and an entropy encoder 260. The mode decision module 230 may select a coding mode from a plurality of available coding modes. Available coding modes may be applied on a per frame, slice, and/or macroblock basis. The coding mode may be selected based on a joint RD cost as described herein. The plurality of available coding modes from which the mode decision module 230 may select the coding mode may include, but are not limited to, intra-modes, inter-modes and/or skip/direct modes. Each of these modes may further involve a selection of a set of motion vectors (out of plurality of motion vectors provided by the motion estimation block) and/or one of a set of quantization parameters. The mode decision block 230 may include a current macroblock RD cost analyzer (current MB RD cost analyzer) 232 coupled to an affected macroblock RD cost analyzer (affected MB RD cost analyzer) 234. The mode decision block 230 may further include a joint RD cost analyzer 236 configured to select an optimum coding mode based on data received from the current MB RD cost analyzer 232 and the affected MB RD cost analyzer 234.

The joint RD optimization process may include evaluating each of the plurality of available coding modes by successively encoding a current macroblock according to each of the plurality of available coding modes (or selected ones of the plurality of available coding modes in some examples) and performing a corresponding joint RD cost analysis for each evaluated coding mode. For each corresponding joint RD cost analysis, the current macroblock analyzer 233 may be configured to determine a rate-distortion cost for a coding mode including a lambda factor λ multiplied by the rate associated with encoding the current macroblock using the evaluated coding mode and the product added to the distortion associated with encoding the current macroblock using the evaluated coding mode. The affected MB RD cost analyzer 234 may be configured to receive information related to the coding mode for the current macroblock from the current MB RD cost analyzer 232 and to provide an aggregated rate-distortion cost of encoding each of one or more of the affected macroblocks based on encoding of the current macroblock using the evaluated coding mode. The aggregated rate-distortion cost may include, for each of the one or more of the affected macroblocks, estimated coding costs, actual coding costs, or a combination thereof. For a given affected macroblock, the affected MB RD cost analyzer 234 may determine an estimated cost to encode the affected macroblock using one or more of available coding modes based on a coding mode being evaluated for the current macroblock, and select a coding mode having a lowest estimated cost. The joint RD cost analyzer 236 may be configured to receive the cost of coding the current macroblock for each mode from the current MB RD cost analyzer 232, and the corresponding aggregated rate-distortion cost of encoding one or more of the affected macroblocks from the affected MB RD cost analyzer 234. The joint RD cost analyzer 236 may be further configured to sum a total cost for each evaluated mode (e.g., cost to encode the current macroblock plus an aggregated cost to encode one or more of the affected macroblock) and select an optimum coding mode based on the sum corresponding to each evaluated coding mode.

In some examples, estimated RD costs for affected macroblocks may be calculated just as those for the current macroblock—e.g. λR+D, where R denotes the true bit cost of encoding the affected macroblock with a specified mode, D denotes the distortion calculated using a selected distortion metric and λ is a Lagrangian optimization parameter. However, it may not be desirable to fully calculate the rate for each affected macroblock, because doing so may involve encoding the affected macroblock to ascertain the rate. Accordingly, estimated RD costs for the affected macroblocks may instead be used in some examples. The estimated RD costs for the affected macroblocks may generally not require encoding the entire affected macroblock, or indeed encoding any of the affected macroblock in some examples. The estimated RD costs for each of the one or more of the affected macroblocks may be based on statistical data (e.g., estimated coding complexity, objective and/or subjective visual quality impacts, etc.). The statistical data may be determined prior to coding the current macroblock and may be based on the evaluated coding mode and on motion information provided by the prediction block 220. The joint RD optimization process further includes selecting a coding mode of the one or more evaluated coding modes based on a comparison of results from each of the corresponding joint RD cost analyses. In an embodiment, a coding mode having a lowest corresponding joint RD cost is selected from the plurality of available coding modes.

The output of the mode decision module 230 may be utilized by a prediction module 220 to generate a predictor in accordance with H.264 normative methods, MPEG-2 normative methods, or other prediction techniques. The predictor may be subtracted from a delayed version of the video signal at the subtractor 204. Using the delayed version of the video signal may provide time for the mode decision block 230 to act. The output of the subtractor 204 may be a residual, e.g. the difference between a macroblock and its prediction.

The transform 206 may be configured to perform a transform, such as a discrete cosine transform (DCT), on the residual to produce a set of blocks of coefficients (typically by processing the residual in blocks of 8×8 pixels or 4×4 pixels) that may, for instance, correspond to spectral components of data in the video signal. Generally, the transform 206 may transform the residual to a frequency domain representation of the residual referred to as a set of coefficient blocks.

The quantization block 208 may be configured to receive the coefficient block and quantize the coefficients of the coefficient block to produce a quantized coefficient block. The quantization provided by the quantization block 208 may be lossy and/or may also utilize a weighting factor (lambda) to adjust and/or optimize rate-distortion tradeoff for one or more coefficients of the coefficient block. Lambda may be received from the mode decision block 230, may be specified by a user, or may be provided by another element of the encoder 250. Lambda may be adjusted for each macroblock or for any other unit, and may be based on information encoded by the encoder 250 (e.g., video signals encoding advertising may utilize a generally larger lambda or smaller lambda inverse than video signals encoding detailed scenes). Lambda may also be common to the mode decision block 230 and the quantization block 208 (i.e. the same parameter is used for rate-distortion optimization of the coding mode and rate-distortion optimization of the quantized coefficients).

The entropy encoder 260 may encode the quantized coefficient block with an encoding technique, such as CAVLC. The entropy encoder 260 may receive syntax elements (e.g., quantized coefficients, differential motion vectors, macroblock modes, etc.) from other devices of the macroblock encoder 250, such as the quantizer 208 and/or prediction module 220. The entropy encoder 260 may be any entropy encoder known by those having ordinary skill in the art or hereafter developed, such as a variable length coding (VLC) encoder or a binary arithmetic coding encoder (e.g. CABAC).

As discussed, in some embodiments, the encoder 250 may operate in accordance with the MPEG-2 video coding standard and the H.264 video coding standard. Thus, because the MPEG-2 and the 11.264 video coding standards employ motion prediction and/or compensation, the encoder 250 may further include a feedback path that includes an inverse quantizer 210, an inverse transform 212, a reconstruction adder 214, and a deblocking filter 216. These elements may mirror elements included in a decoder (not shown) that is configured to reverse, at least in part, the encoding process performed by the encoder 250. Additionally, the feedback loop of the encoder may include a decoded picture buffer 218 and the prediction block 220.

The quantized coefficient block may be inverse quantized by the inverse quantizer (Q⁻¹) 210 to provide recovered coefficients, and the recovered coefficients for a macroblock may be inverse transformed by the inverse transform (T⁻¹) 212 to produce a reconstructed macroblock residual. The reconstructed residual may be added to the predictor at the reconstruction adder 214 and after combining with the remaining reconstructed macroblocks produce reconstructed video frame, which may be deblocked by the deblocking filter 216, written to the decoded picture buffer 218 for use for prediction in encoding subsequent frames, and fed back to the macroblock prediction module 220 and to the mode decision block 230 for further in-macroblock intra prediction or other mode decision methodologies. In some examples, the deblocking filter may be removed or bypassed, and the reconstructed video frame may be provided directly to the decoded picture buffer 218 from the reconstruction adder 214.

In an example operation of the encoder 250, a video signal (e.g., a base band video signal) may be provided to the encoder 250. The video signal may be provided to the delay buffer 202 and the mode decision block 230. The subtractor 204 may receive the video signal from the delay buffer 202 and may subtract a motion prediction signal from the video signal to generate a residual. The residual may be provided to the transform 206 and processed using a forward transform, such as a DCT. The transform 206 may generate a coefficient block that may be provided to the quantizer 208, and the quantizer 208 may quantize the coefficient block. Quantized coefficients and other syntax elements may be provided to the entropy encoder 260 and encoded into an encoded bitstream.

As explained above, the block of quantized coefficients may be inverse quantized, inverse transformed, and added to the motion prediction signal by the inverse quantization block 210, the inverse transform 212, and the reconstruction adder 214, respectively, to produce a reconstructed video signal. Both the prediction block 220 and the deblocking filter 216 may receive the reconstructed video signal, and the decoded picture buffer 218 may receive a filtered video signal from the deblocking filter 216 or the reconstructed video signal directly from the reconstruction adder 214. Based on the reconstructed and filtered video signals, the prediction block 220 may provide a motion prediction signal to the adder.

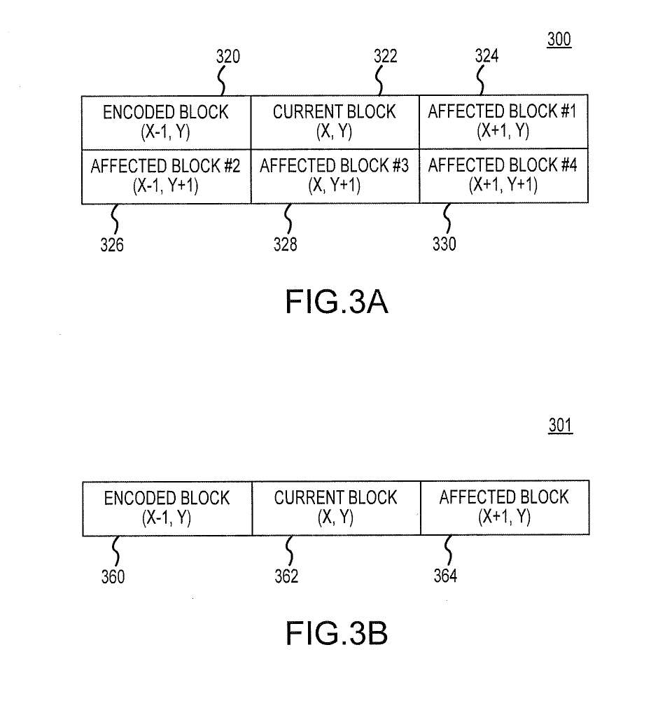

As explained above, a coding mode decision may be made by the mode decision block 230 by conducting a joint RD optimization operation on a current macroblock of a frame of video data of the video signal. The joint RD optimization operation may include successively encoding a current macroblock of a frame of video data using each of plurality of available coding modes and selecting a coding mode of the plurality of available coding modes based on a comparison of results corresponding to each joint RD cost analysis. To perform joint RD optimization, the mode decision block 230 may receive inputs from the transform 206, quantization 208, entropy encoder 260, and/or other components of the encoding system 200 that provide information relevant to the rate-distortion cost associated with a coding mode. For example, based on the reconstructed and optionally filtered video signals received from the picture buffer 218, the current MB RD cost analyzer 232 of the mode decision block 230 may determine a corresponding RD cost of coding a current macroblock using the current coding mode as part of the joint RD optimization operation. Encoding of subsequent macroblocks of the frame of the video data may be affected by a coding mode selected for a current macroblock. Examples of affected macroblocks may be described further with reference to FIGS. 3a (in case of H.264 encoding) and 3b (in case of MPEG-2 encoding). Thus, the joint RD optimization process may further account for an effect a coding mode for a current macroblock may have on the affected macroblocks by factoring an RD cost for one or more of the affected macroblocks (e.g., estimated RD cost or actual RD cost, or a combination thereof), as determined by the affected MB RD cost analyzer 234, into the joint RD cost analysis. In some embodiments, the one or more of the affected macroblocks may include each of the affected macroblocks. The joint RD cost analyzer 236 may select an optimum mode based on a lowest cost sum of the evaluated coding modes, where a sum for each of the evaluated coding modes includes cost to encode the current macroblock plus the associated rate-distortion cost of encoding one or more of the affected macroblocks.

An example of calculating a joint rate-distortion cost for different coding modes in the MPEG-2 video coding standard will now be discussed. The example calculations may be performed, for example, by the mode decision block 230 of FIG. 2. It is to be understood that other coding standards may be used in other embodiments of the present invention. Each coding standard may have a different set of affected macroblocks relative to a current macroblock. In the MPEG-2 video coding standard, the choice of a coding mode for one macroblock may affect the macroblock to the right because a set of predictors (e.g. DC and motion information) may be generated based on the encoded macroblock and used in coding the macroblock to the right. Accordingly, if a locally optimal mode was selected for encoding a macroblock, it may cause using a reset predictor for the macroblock to the right if an opposite coding mode was then determined to be optimal for that macroblock. Alternatively, selecting a locally suboptimal mode for encoding one macroblock may allow bit savings in encoding the DC or motion information differentials for the macroblock to the right, yielding a more globally optimal decision.

When using the MPEG-2 video coding standard, macroblocks may be encoded using intra-coding or inter-coding (e.g. intra-coding and inter-coding may be two coding modes that may be selected between by a mode decision block such as the mode decision block 230 of FIG. 2). Further, encoding of a current macroblock of a frame may be affected by the encoding of a previously encoded macroblock within the frame and to the left. Encoding of the macroblock may use a discrete cosine function to determine discrete cosine coefficients. When evaluating the intra-coding mode for a macroblock in MPEG-2, the estimated cost of encoding the current macroblock may include at least one of a sum of activity (e.g., difference between a macroblock of pixels and its copy shifted by one or more pixels vertically, horizontally, or a combination thereof, computed on a frame or field basis) or an estimated cost to encode differentials of the DC coefficients of the DCT. The estimated cost to encode the differentials of the DC coefficients may be dependent on a coding mode of the macroblock to the left. If the macroblock to the left is encoded using intra-coding, estimated cost to encode the differentials of the DC coefficients may be a difference between the DC coefficients of the current macroblock and the DC coefficients of the macroblock to the left. If the macroblock to the left is encoded using inter-coding, an estimated cost to encode the differentials of the DC coefficients may be a difference between the DC coefficients of the current macroblock and a fixed predictor (e.g., 128 based on the MPEG-2 specification). Accordingly, the cost of coding one macroblock may be affected by the coding selection of the block to the left. Embodiments of the present invention may take into consideration the effect on the macroblock to the right when making a mode decision for the current macroblock.

When evaluating the inter-coding mode for a macroblock in MPEG-2, the estimated cost of encoding the current macroblock may be calculated as a combination of distortion of a best matched macroblock of one or more previously encoded frames determined by the macroblock prediction block 220 and an estimated cost to encode motion vector differentials. The motion vector differentials may be calculated as a difference between desired motion vectors and motion vector predictors. The estimated cost to encode the motion vector differentials may be dependent on a coding mode of the macroblock to the left. If the macroblock to the left is encoded using intra-coding, the motion vector predictors may be reset to zero, so the motion vector differential may be a magnitude associated with encoding an entire value of the desired motion vectors. If the macroblock to the left is encoded using inter-coding, the motion vectors used in the macroblock to the left may become the motion vector predictors for the current macroblock, and the motion vector differentials may be associated with a difference between the desired motion vectors and the motion vector predictors. Accordingly, the cost of coding one macroblock may be affected by the coding selection of the block to the left. Embodiments of the present invention may take into consideration the effect on the macroblock to the right when making a mode decision for the current macroblock.

The above example is provided for illustrative purposes, and is not intended to limit the disclosure. One having ordinary skill in the art would recognize that encoding of macroblocks using other video coding standards may include estimates of other dependencies and parameters and may include a plurality of affected macroblocks. Rather than fully encoding one or more of the affected macroblocks to determine an actual RD cost to encode the one or more of the affected macroblocks in terms of a coding decision for a current macroblock, the mode decision block 230 estimates the RD cost for one or more of the affected macroblocks. Eliminating a need to encode each of the one or more of the affected macroblocks to as part of a joint RD optimization operation for a current macroblock may result in a significant reduction in required computational resources.

FIG. 3a is an illustration of a portion of frame 300 of a video signal (e.g. video data) according to an embodiment of the disclosure. FIG. 3a depicts six macroblocks within the portion of the frame 300. As explained above, in some embodiments, an encoder, such as the encoder 150 of FIG. 1 and/or the encoder 250 of FIG. 2, may operate in accordance with the H.264 video coding standard. According to the H.264 video coding standard, coding of a macroblock may be affected by a previously encoded macroblock. For example, encoded macroblock 320 has previously been encoded and current macroblock 322 is a next macroblock to be encoded. Affected macroblocks 324, 326, 328, and 330 may be encoded after the current macroblock is encoded. According to the H.264 video coding standard, encoding of a current macroblock may affect adjacent macroblocks to be encoded to the right, lower right, lower center, and lower left of the current macroblock. Thus, a coding mode used to encode the current macroblock 322 may affect a rate-distortion cost to subsequently encode the affected macroblocks 324, 326, 328, and 330. Accordingly, joint rate-distortion calculations described herein may include costs associated with encoding some or all of the macroblocks 324, 326, 328, and 330 when making a decision on coding mode for the macroblock 322.

FIG. 3b is another illustration of a portion of a frame 301 of a video signal (e.g. video data) according to an embodiment of the disclosure. FIG. 3b depicts three macroblocks within the portion of the frame 301. As explained above, in some embodiments, an encoder, such as the encoder 150 of FIG. 1 and/or the encoder 250 of FIG. 2, may operate in accordance with the MPEG-2 video coding standard. According to the MPEG-2 video coding standard, coding of a macroblock may be affected by a previously encoded macroblock. For example, encoded macroblock 360 has previously been encoded and current macroblock 362 is a next macroblock to be encoded. Affected macroblock 364 may be encoded after the current macroblock is encoded. According to the MPEG-2 video coding standard, a macroblock to be encoded may be affected by the coding of an adjacent macroblock to the left. Thus, a coding mode used to encode the current macroblock 362 may be affecting a rate-distortion cost to subsequently encode the affected macroblock 364. Accordingly, joint rate-distortion calculations described herein may include costs associated with encoding the macroblock 364 when making a mode decision for encoding the macroblock 362.

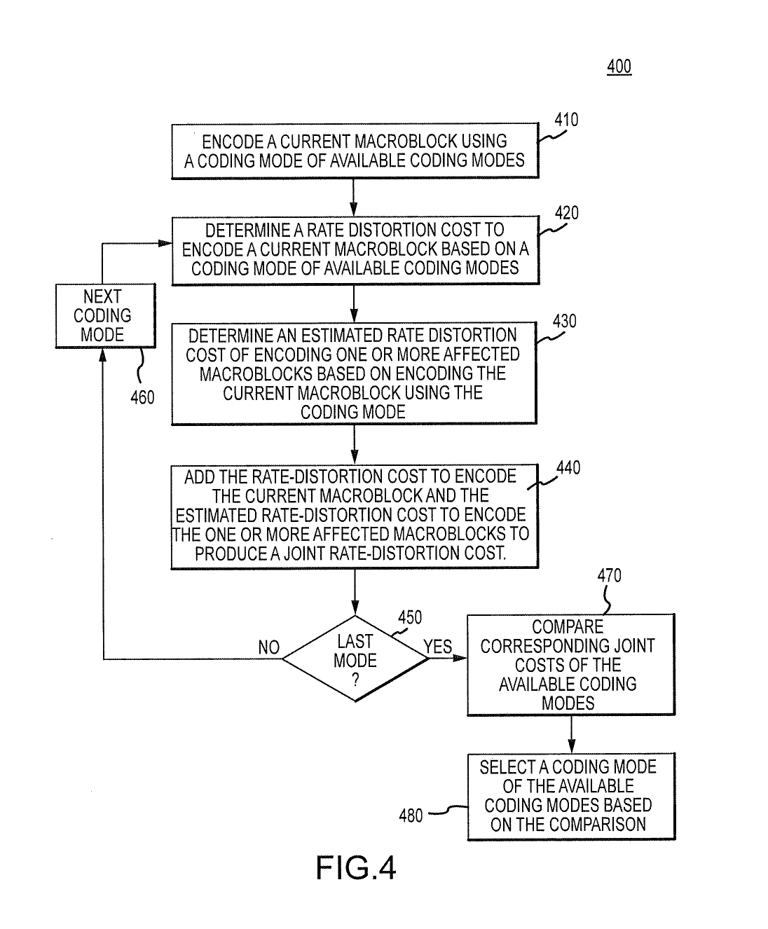

FIG. 4 is a flowchart 400 for a method for selecting a coding mode using joint RD optimization according to an embodiment of the disclosure. The method illustrated by the flowchart 400 may be implemented by the encoder 150 of FIG. 1, the encoder 250 of FIG. 2, or any combination thereof.

The method 400 may include successively encoding a macroblock using a plurality of coding modes, at 410. The macroblock may be encoded using the encoder 150 of FIG. 1 or the encoder 250 of FIG. 2, or any combination thereof. In an embodiment, the plurality of coding modes may include an intra-coding mode and a plurality of inter-coding modes. The method may further include determining a corresponding rate-distortion cost to encode the macroblock based on each coding mode, or selected ones of the coding modes of the plurality of coding modes, at 420. The corresponding rate-distortion cost may be determined by the mode decision block 230 of FIG. 2.

The method 400 may further include determining a corresponding estimated rate-distortion cost to encode one or more of the macroblocks affected by encoding the macroblock using the corresponding coding mode, at 430. The corresponding estimated rate-distortion cost may be determined by the mode decision block 230 of FIG. 2. In some embodiments, the method 400 may further include, for a coding mode of the plurality of coding modes, adding the corresponding rate-distortion cost to encode the macroblock and the corresponding estimated rate-distortion cost to encode the one or more of the affected macroblocks to produce a corresponding joint rate-distortion cost, at 440.

In a particular embodiment, the method 400 may determine estimated costs, which may be based, not on an actual encoding of the affected macroblocks, but a statistical analysis of the affected macroblocks (e.g. the features of those macroblocks that may affect the cost, such as complexity of the macroblock). In an embodiment, the method 400 includes receiving a reconstructed macroblock based on the encoded macroblock. The reconstructed macroblock includes motion information, and estimating the corresponding rate-distortion cost for each of the affected macroblocks may be based on the motion information.

In some embodiments, the corresponding estimated rate-distortion cost to encode the one or more macroblocks based on a corresponding coding mode of a current macroblock may include a combination of actual costs to encode some of the one or more of the affected macroblocks and the estimated cost to encode remaining macroblocks of the one or more of the affected macroblocks. For example, the method may including determining actual RD costs for a subset of the one or more of the affected macroblocks by fully encoding the subset of the one or more of the affected macroblocks based on a coding mode of the current macroblock. Thus, the corresponding estimated rate-distortion cost to encode the one or more of the macroblocks based on a corresponding coding mode of a current macroblock may include a sum of the actual cost to encode the subset of the one or more of the affected macroblocks and the estimated cost to encode remaining macroblocks of the one or more of the affected macroblocks. In some embodiments, the method 400 may further include determining whether each coding mode of the plurality of coding modes have been evaluated, at 450, and if not, select a next coding mode, at 460.

In some embodiments, when each of the plurality of coding modes have been evaluated, the method may further include comparing the corresponding joint rate-distortion costs of one or more of the plurality of available modes (e.g., evaluated coding modes), at 470. The method may further include selecting a coding mode of the evaluated coding modes based on a comparison of each of the corresponding joint rate-distortion costs. The corresponding total rate-distortion cost may include the corresponding rate-distortion cost to encode the macroblock and the corresponding estimated rate-distortion cost to encode the one or more of the affected macroblocks, at 480. In an embodiment, selecting the coding mode may include selecting the coding mode of the plurality of coding modes having a lowest corresponding joint rate-distortion cost. The method 400 may further include providing the macroblock encoded using the selected coding mode.

In a first, non-limiting example using MPEG-2 encoding, the mode decision block may evaluate at least two coding modes—intra-coding and inter-coding. In evaluating intra-coding, a joint rate-distortion cost may be calculated for intra-coding of the current macroblock that includes a rate-distortion cost for intra-coding of the current macroblock plus an estimated cost for coding the macroblock to the right (e.g. the affected macroblock in MPEG-2 encoding). As described above, in some examples the estimated cost for coding the affected macroblock may be weighted prior to summing with the rate-distortion cost of the current frame. The estimated rate-distortion cost for coding the macroblock to the right may, if the macroblock to the right is also intra-frame encoded, be provided by determining a sum of activity (e.g. a difference between a block of pixels of the macroblock to the right and the same block of pixels shifted by one or more pixels) and/or a cost to encode differentials of DC coefficients of a discrete cosine transform. Since intra-coding is being evaluated for the current macroblock, the cost to encode the differentials of the DC coefficients will be the difference between DC values of the macroblock to the right and the current macroblock being evaluated. Accordingly, this process may generate a first joint RD cost associated with encoding a first macroblock using an intra-coding mode and a macroblock to the right also using an intra-coding mode.

Another joint RD cost may be calculated as associated with encoding the first macroblock using an intra-coding mode and the macroblock to the right using a non-intra-coding mode. In such a case, the joint RD cost may be the RD cost for encoding the current macroblock using the intra-coding mode plus an (optionally weighted) estimated cost of encoding the macroblock to the right using a non-intra-coding mode (e.g. an inter-coding mode). The estimated cost of encoding the macroblock to the right using a non-intra-coding mode may be calculated as a combination of distortion of a best temporal match determined by a motion estimation module and/or an estimated bit cost of coding the motion vector differentials. The motion vector differentials may be calculated as the difference between the desired motion vectors and the motion vector predictors. Given that intra-coding is being evaluated for the current macroblock, the motion vector predictors may be reset to 0, and the entire value of the motion vectors selected for the macroblock to the right may be coded as is, resulting in a likely higher cost. Accordingly, this process may generate a second joint RD cost associated with encoding a first macroblock using an intra-coding mode and a macroblock to the right using an inter-coding mode.

In evaluating inter-coding for the current macroblock, a joint RD cost may be calculated for the current macroblock that includes the RD cost for inter-coding of the current macroblock plus an estimated cost of coding the macroblock to the right. If the macroblock to the right is encoded using an intra-coding mode, the estimated cost may be given as a sum of activity (e.g. a difference between a block of pixels and its copy shifted by one or more pixels vertically) and/or an estimated cost to encode differentials of DC coefficients. The value of the differentials of the DC coefficients, given inter-coding of the current macroblock, may be the difference between the DC value of the macroblock to the right and a fixed predictor (e.g. 128 based on the MPEG-2 specification). This process may generate a third joint RD cost associated with encoding a first macroblock in an inter-coding mode and a macroblock to the right in an intra-coding mode.

Another joint RD cost may be calculated associated with encoding the first macroblock using an inter-coding mode and the macroblock to the right using an inter-coding mode. In such a case, the joint RD cost may be the RD cost for encoding the current macroblock using the inter-coding mode plus an (optionally weighted) estimated cost of encoding the macroblock to the right using a non-intra-coding mode (e.g. an inter-coding mode). The estimated cost of encoding the macroblock to the right with an inter-coding mode may be calculated as a combination of distortion of a best temporal match determined by a motion estimation module 220 and an estimated bit cost of coding the motion vector differentials. The motion vector differentials may be calculated as the difference between the desired motion vectors and the motion vector predictors. Given that inter-coding is being evaluated for the current macroblock, the motion vectors for the current macroblock become the predictors for the macroblock to the right making it necessary to only encode the difference between the motion vectors and corresponding predictors, and this information may be used to generate the estimated cost. Accordingly, this process may generate a fourth joint RD cost associated with encoding a first macroblock using an inter-coding mode and a macroblock to the right also using an inter-coding mode.

The four generated joint RD costs may be compared to select an optimal coding mode for the current macroblock and, optionally also the macroblock to the right. For example, the modes associated with the lowest of the four joint RD costs may be selected and used to encode the macroblocks.

The method 400 may be implemented by a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, the method 400 of FIG. 4 may be implemented by a computing system using, for example, one or more processing units that may execute instructions for performing the method that may be encoded on a computer readable medium. The processing units may be implemented using, e.g. processors or other circuitry capable of processing (e.g. one or more controllers or other circuitry). The computer readable medium may be transitory or non-transitory and may be implemented, for example, using any suitable electronic memory, including but not limited to, system memory, flash memory, solid state drives, hard disk drives, etc. One or more processing units and computer readable mediums encoding executable instructions may be used to implement all or portions of encoders or encoding systems described herein.

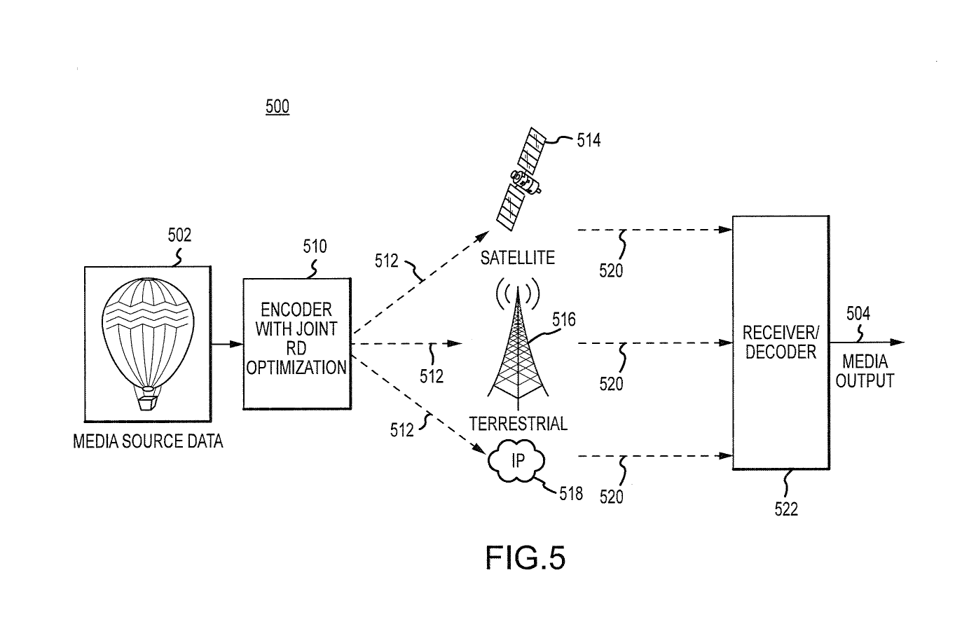

FIG. 5 is a schematic illustration of a media delivery system in accordance with embodiments. The media delivery system 500 may provide a mechanism for delivering a media source 502 to one or more of a variety of media output(s) 504. Although only one media source 502 and media output 504 are illustrated in FIG. 5, it is to be understood that any number may be used, and examples may be used to broadcast and/or otherwise deliver media content to any number of media outputs.

The media source data 502 may be any source of media content, including but not limited to, video, audio, data, or combinations thereof. The media source data 502 may be, for example, audio and/or video data that may be captured using a camera, microphone, and/or other capturing devices, or may be generated or provided by a processing device. Media source data 502 may be analog or digital. When the media source data 502 is analog data, the media source data 502 may be converted to digital data using, for example, an analog-to-digital converter (ADC). Typically, to transmit the media source data 502, some type of compression and/or encryption may be desirable. Accordingly, an encoder with joint rate-distortion optimization 510 may be provided that may encode the media source data 502 using any encoding method in the art, known now or in the future, including encoding methods in accordance with video standards such as, but not limited to, MPEG-2, MPEG-4, H.264, HEVC, or combinations of these or other encoding standards. The encoder with joint rate-distortion optimization 510 may be implemented using any encoder described herein, including the encoder 150 of FIG. 1 and the encoder 250 of FIG. 2, and further may be used to implement the method 400 of FIG. 4.

The encoded data 512 may be provided to a communications link, such as a satellite 514, an antenna 516, and/or a network 518. The network 518 may be wired or wireless, and further may communicate using electrical and/or optical transmission. The antenna 516 may be a terrestrial antenna, and may, for example, receive and transmit conventional AM and FM signals, satellite signals, or other signals known in the art. The communications link may broadcast the encoded data 512, and in some examples may alter the encoded data 512 and broadcast the altered encoded data 512 (e.g., by re-encoding, adding to, or subtracting from the encoded data 512). The encoded data 520 provided from the communications link may be received by a receiver 522 that may include or be coupled to a decoder. The decoder may decode the encoded data 520 to provide one or more media outputs, with the media output 504 shown in FIG. 5.

The receiver 522 may be included in or in communication with any number of devices, including but not limited to a modem, router, server, set-top box, laptop, desktop, computer, tablet, mobile phone, etc.

The media delivery system 500 of FIG. 5 and/or the encoder with joint rate-distortion optimization 510 may be utilized in a variety of segments of a content distribution industry.

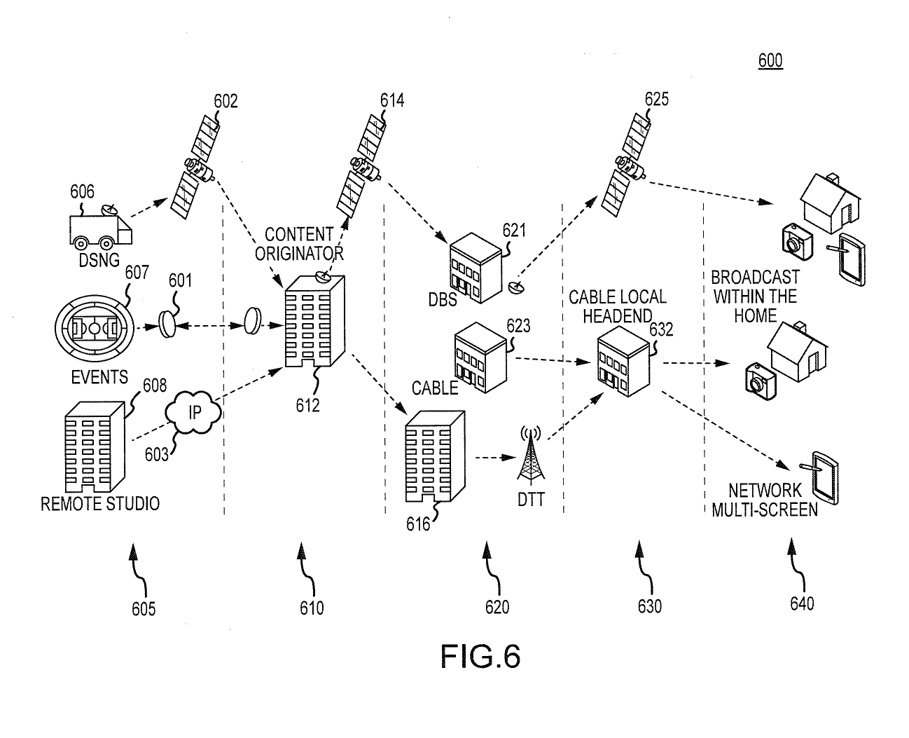

FIG. 6 is a schematic illustration of a video distribution system that 600 may make use of encoders described herein. The video distribution system 600 includes video contributors 605. The video contributors 605 may include, but are not limited to, digital satellite news gathering systems 606, event broadcasts 607, and remote studios 608. Each or any of these video contributors 605 may utilize an encoder described herein, such as the encoder with joint rate-distortion optimization 510 of FIG. 5, to encode media source data and provide encoded data to a communications link. The digital satellite news gathering system 606 may provide encoded data to a satellite 602. The event broadcast 607 may provide encoded data to an antenna 601. The remote studio 608 may provide encoded data over a network 603.

A production segment 610 may include a content originator 612. The content originator 612 may receive encoded data from any or combinations of the video contributors 605. The content originator 612 may make the received content available, and may edit, combine, and/or manipulate any of the received content to make the content available. The content originator 612 may utilize encoders described herein, such as the encoder with joint rate-distortion optimization 510 of FIG. 5, to provide encoded data to the satellite 614 (or another communications link). The content originator 612 may provide encoded data to a digital terrestrial television system 616 over a network or other communication link. In some examples, the content originator 612 may utilize a decoder to decode the content received from the contributor(s) 605. The content originator 612 may then re-encode data; potentially utilizing encoders described herein, such as the encoder with joint rate-distortion optimization 510, and provide the encoded data to the satellite 614. In other examples, the content originator 612 may not decode the received data, and may utilize a transcoder (which may consist of an encoder with joint rate-distortion optimization 510) to change an encoding format of the received data.

A primary distribution segment 620 may include a digital broadcast system 621, the digital terrestrial television system 616, and/or a cable system 623. The digital broadcasting system 621 may include a receiver, such as the receiver 522 described with reference to FIG. 5, to receive encoded data from the satellite 614. The digital terrestrial television system 616 may include a receiver, such as the receiver 522 described with reference to FIG. 5, to receive encoded data from the content originator 612. The cable system 623 may host its own content which may or may not have been received from the production segment 610 and/or the contributor segment 605. For example, the cable system 623 may provide its own media source data 502 as that which was described with reference to FIG. 5.

The digital broadcast system 621 may include an encoder, such as the encoder with joint rate-distortion optimization 510 described with reference to FIG. 5, to provide encoded data to the satellite 625. The cable system 623 may include an encoder, such as the encoder with joint rate-distortion optimization 510 described with reference to FIG. 5, to provide encoded data over a network or other communications link to a cable local headend 632. A secondary distribution segment 630 may include, for example, the satellite 625 and/or the cable local headend 632.

The cable local headend 632 may include an encoder, such as the encoder with joint rate-distortion optimization 510 described with reference to FIG. 5, to provide encoded data to clients in a client segment 540 over a network or other communications link. The satellite 625 may broadcast signals to clients in the client segment 640. The client segment 640 may include any number of devices that may include receivers, such as the receiver 522 and associated decoder described with reference to FIG. 5, for decoding content, and ultimately, making content available to users. The client segment 640 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An encoding system, comprising:
an encoder configured to encode a macroblock of a frame, wherein the encoder comprises a mode decision module configured to select a coding mode of a plurality of coding modes used to encode the macroblock based on a corresponding joint rate-distortion cost, wherein the corresponding rate-distortion cost includes a corresponding rate-distortion cost to encode the macroblock and a corresponding estimated cost to encode one or more of the affected macroblocks, wherein the mode decision module is configured to generate the corresponding estimated cost to encode the one or more of the affected macroblocks based, at least in part, on corresponding data.

2. The encoding logic circuit of claim 1, wherein the corresponding data comprises corresponding statistical data.

3. The encoding logic circuit of claim 1, wherein the corresponding statistical data includes at least one of estimated coding complexity data, objective visual quality data, and subjective visual quality data.

4. The encoding logic circuit of claim 1, wherein the encoder further includes a prediction module configured to provide corresponding motion information to the mode decision block, wherein the mode decision module is further configured to generate the corresponding estimated cost to encode the one or more of the affected macroblocks based on the motion information.

5. The encoding logic circuit of claim 1, wherein the encoder is configured to receive a video signal, wherein the video signal includes video data, wherein the video data includes a frame including the macroblock and the one or more of the affected macroblocks.

6. The encoding logic circuit of claim 1, wherein the encoder is configured to determine a corresponding rate-distortion cost to encode the macroblock by encoding the macroblock using a corresponding coding mode of the plurality of coding modes, and receiving a reconstructed macroblock corresponding to the encoded macroblock, wherein the reconstructed macroblock includes the encoded macroblock decoded.

7. The encoding system of claim 1, wherein the macroblock of the frame is encoded in accordance with MPEG-2, and the affected macroblocks include at least a macroblock to the right of the macroblock.

8. The encoding system of claim 1, wherein the macroblock of the frame is encoded in accordance with H.264 and the affected macroblocks include at least one or more of adjacent macroblocks to the right, lower right, lower center, and lower left of the macroblock.

9. The encoding system of claim 1, wherein the macroblock of the frame is encoded in accordance with any context-based predictive video encoding method and the affected macroblocks can be derived from the context-based predictive method as defined in the encoding method.

10. A non-transitory computer-readable medium comprising instructions that, when executed by one or more processing units, cause the one or more processing units to:
successively encode a macroblock using a plurality of coding modes;
determine a corresponding rate-distortion cost to encode the macroblock based on a corresponding coding mode of the plurality of coding modes;
determine a corresponding estimated rate-distortion cost to encode one or more macroblocks affected by encoding the macroblock using the corresponding coding mode; and
select a coding mode of the plurality of coding modes having a lowest corresponding joint rate-distortion cost, wherein the corresponding joint rate-distortion cost comprises the corresponding rate-distortion cost to encode the macroblock and the corresponding estimated rate-distortion cost to encode the one or more of the affected macroblocks.

11. The non-transitory computer-readable medium of claim 10, further comprising instructions that, when executed by the one or more processing units, cause the one or more processing units to, for each coding mode of the plurality of coding modes, add the corresponding rate-distortion cost to encode the macroblock and the weighted corresponding estimated rate-distortion cost to encode the one or more of the affected macroblocks to produce the corresponding joint rate-distortion cost.

12. The non-transitory computer-readable medium of claim 10, further comprising instructions that, when executed by the one or more processing units, cause the one or more processing units to receive a reconstructed macroblock based on the encoded macroblock, wherein the reconstructed macroblock includes motion information, wherein estimating the corresponding rate-distortion cost for each of the affected macroblocks is based on the motion information.

13. The non-transitory computer-readable medium of claim 10, wherein the plurality of coding modes comprise an intra-coding mode and one or more inter-coding modes.

14. The non-transitory computer-readable medium of claim 10, further comprising instructions that, when executed by the one or more processing units, cause the computer to determine statistical data, wherein the corresponding estimated rate-distortion cost to encode the one or more macroblocks affected by encoding the macroblock using the corresponding coding mode based on the statistical data.

15. The non-transitory computer-readable medium of claim 10, further comprising instructions that, when executed by the one or more processing units, cause the one or more processing units to provide the macroblock encoded using the selected coding mode.

16. A method, comprising:
encoding a first macroblock of a frame using a first coding mode at an encoder;
determining a first joint rate-distortion cost, wherein the first joint rate-distortion cost is based on a first rate-distortion cost to encode the first macroblock using the first coding mode and a first estimated rate-distortion cost, wherein the first estimated rate-distortion cost comprises an estimated cost to encode a second macroblock of the frame affected by encoding the first macroblock using the first coding mode; and
encoding the first macroblock using a second coding mode;
determining a second joint rate-distortion cost, wherein the second joint rate-distortion cost is based on a second rate-distortion cost to encode the first macroblock using the second coding mode and a second estimated rate-distortion cost, wherein the second estimated rate-distortion cost comprises an estimated cost to encode the second macroblock affected by encoding the first macroblock using the second coding mode; and
selecting a coding mode of at least the first coding mode and the second coding mode based on a comparison of the first joint rate-distortion cost and the second joint rate-distortion cost.

17. The method of claim 16, wherein the first estimated rate-distortion cost further comprises a cost to encode one or more additional macroblocks of the frame affected by encoding the first macroblock using the first coding mode, and wherein the second estimated rate-distortion cost further comprises a cost to encode the one or more additional macroblocks of the frame affected by encoding the first macroblock using the second coding mode.

18. The method of claim 17, wherein:
the first estimated rate-distortion cost further comprising a cost to encode the one or more additional macroblocks of the frame affected by encoding the first macroblock using the first coding mode comprises:
determining an actual cost to encode at least one macroblock of the one or more macroblocks based on the first coding mode of the first macroblock; and
determining an estimated cost to encode remaining macroblocks of the one or more macroblocks based on the first coding mode of the first macroblock; and
the second estimated rate-distortion cost further comprising a cost to encode the one or more additional macroblocks of the frame affected by encoding the first macroblock using the second coding mode comprises:
determining an actual cost to encode the at least one macroblock of the one or more macroblocks based on the second coding mode of the first macroblock; and
determining an estimated cost to encode the remaining macroblocks of the one or more macroblocks based on the second coding mode of the first macroblock.

19. The method of claim 16, wherein encoding the first macroblock using the first coding mode comprises encoding the macroblock using intra-coding; and the method further comprising determining the estimated rate-distortion cost to encode the second macroblock affected by encoding the first macroblock using the first coding mode comprises:
determining a first sum, wherein the first sum comprises at least one of:
a difference between a block of pixels of the second macroblock and the block of pixels shifted by one or more pixels; or
a cost to encode differentials of DC coefficients of a discrete cosine transform, wherein the differentials of the DC coefficients are based on a difference between a DC coefficient of the first macroblock and a DC coefficient of the second macroblock;
determining a second sum comprising at least one of distortion of a matched macroblock of a previous frame or one or more of:
a count of estimated bits required to encode motion information of the second macroblock; or
a count of estimated bits to encode header information associated with a video encoding methodology; and
selecting a lowest of the first sum and the second sum as the first estimated rate-distortion cost.

20. The method of claim 16, wherein encoding the first macroblock using the second coding mode comprises encoding the macroblock using inter-coding; and the method further comprising determining the estimated rate-distortion cost to encode the second macroblock affected by encoding the first macroblock using the second coding mode comprises:
determining a first sum, wherein the first sum comprises at least one of:
a difference between a block of pixels of the second macroblock and the block of pixels shifted by one or more pixels; and
a cost to encode differentials of DC coefficients, wherein the differentials of the DC coefficients are based on a difference between a DC coefficient of the second macroblock and a fixed predictor;
determining a second sum of distortion of a matched macroblock of one or more of the previously encoded frames and a count of estimated bits required to encode one or more of:
motion information of the second macroblock, wherein the motion information is based on a difference between a desired motion vector and a motion vector predictor provided by the first macroblock; or
header information associated with a video encoding methodology; and
selecting a lowest of the first sum and the second sum as the first estimated rate-distortion cost.

21. The method of claim 16, further comprising:
comparing the first joint rate-distortion cost and the second total rate-distortion cost; and
selecting the coding mode of the first coding mode and the second coding mode having a lowest total cost.

22. The method of claim 16, further comprising providing, at an output of the encoder, an encoded bitstream including the first macroblock encoded using the selected coding mode.
